(19) United States
(12) Patent Application Publication
(10) Pub. No.: US 2016/0171365 A1
(43) Pub. Date: Jun. 16, 2016

(54) CONSUMER PREFERENCES FORECASTING AND TRENDS FINDING

(71) Applicant: Oleksiy STEPANOVSKIY, Kharkiv (UA)

(72) Inventor: Oleksiy STEPANOVSKIY, Kharkiv (UA)

(21) Appl. No.: 14/968,838

(22) Filed: Dec. 14, 2015

Related U.S. Application Data
(60) Provisional application No. 62/091,620, filed on Dec. 14, 2014.

(51) Int. Cl. G06N 3/04; G06N 3/063

(52) U.S. Cl. CPC G06N 3/0436; G06N 3/063

(57) ABSTRACT

A method uses input datasets for continuous color, fashion features and brand content and a fuzzy neural network or other comparable models to generate consumer brand preference information, consumer color preference information and information on apparel fashion features.

### CLAIM OF PRIORITY

The present invention is a nonprovisional of and claims priority from U.S. Provisional Patent Application No. 62/091,620, filed Dec. 14, 2014, entitled Fuzzy Neural Based Forecasting of Consumer Preferences, the entirety of which is hereby incorporated by reference as if fully set forth herein.

### BACKGROUND OF THE INVENTION

The present invention relates generally to the field of computer communication systems and methods and more specifically to computer communication systems and methods for forecasting consumer preferences as a decision support system.

Extending from New York to Milan, Paris to London and many other cities in the world, the fashion industry is global and ubiquitous. To be sure, the trends for this industry change every year and may be cyclical; a brand that dominates this year may not do so the next year.

A designer, fashion or apparel manufacture usually estimates what apparel, colors or the like will be popular each season. Sometimes, such a forecast is accurate. If the forecast is inaccurate, a manufacturer (for example) will either manufacture too much or too little of a particular apparel, design or color.

If too much apparel is manufactured, the manufactured items sit on the shelves as overstock after which they are often discounted for sale, donated or recycled. If the too little apparel is produced, the manufacturer does not effectively capitalize on demand and cannot boost its profit as there are no products to meet consumer demand.

It is within the aforementioned context that a need for the present invention has arisen. There is a need to address one or more of the foregoing disadvantages of conventional systems and methods, and the present invention meets this need.

### BRIEF SUMMARY OF THE INVENTION

Various aspects of consumer preferences forecasting system and method are disclosed in exemplary embodiments of the present invention.

A first embodiment is a computer-implemented method that might include a server receiving two input datasets including a first dataset and a second dataset. Here, the first dataset is at least continuous color data, and might also include fashion features data for apparel. The continuous color data is then applied to a defuzzification unit.

The second dataset is at least discrete brand data that is then applied to an artificial neural network. Note that other analytical models may be used in lieu or in addition to the artificial neural network.

A third dataset based on the first dataset that is applied to the defuzzification unit is then generated and also applied to the artificial neural network. Further yet, a fourth dataset and a fifth dataset that are based on the second dataset and the third dataset that were applied to the artificial neural network are then generated.

The fourth dataset is applied to a fuzzification unit while the fifth dataset is output, indicating consumer brand preference information that may be associated with future time duration. A sixth dataset based on the fourth dataset applied to the fuzzification unit is also generated and output, indicating consumer color preference and fashion features information for apparel.

In another embodiment, actual consumer preference data is used to tune/train a fuzzy neural network for forecasting consumer fashion preferences. Consumer preference data might include continuous information such as color. Consumer preference data might also include discrete information such as brand name information. Such data might be obtained from actual sales data indicating the brand names that are sold, for example. Data may also be obtained from the Internet that might for example, indicate prevalence of certain colors as consumer preferences.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 illustrates a preferences communication system according to an exemplary embodiment of the present invention.

FIG. 2 illustrates a fuzzy-neural system according to an exemplary embodiment of the present invention.

FIG. 3 illustrates an exemplary data input interface for the fuzzy-neural system of FIG. 2.

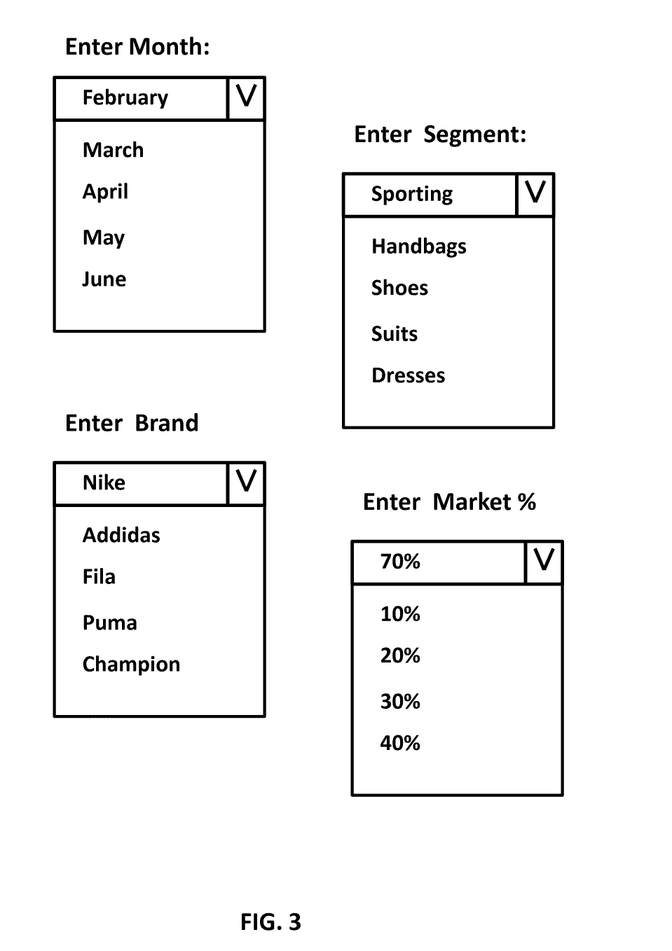

FIG. 4 illustrates an exemplary data input interface for the fuzzy-neural system of FIG. 2.

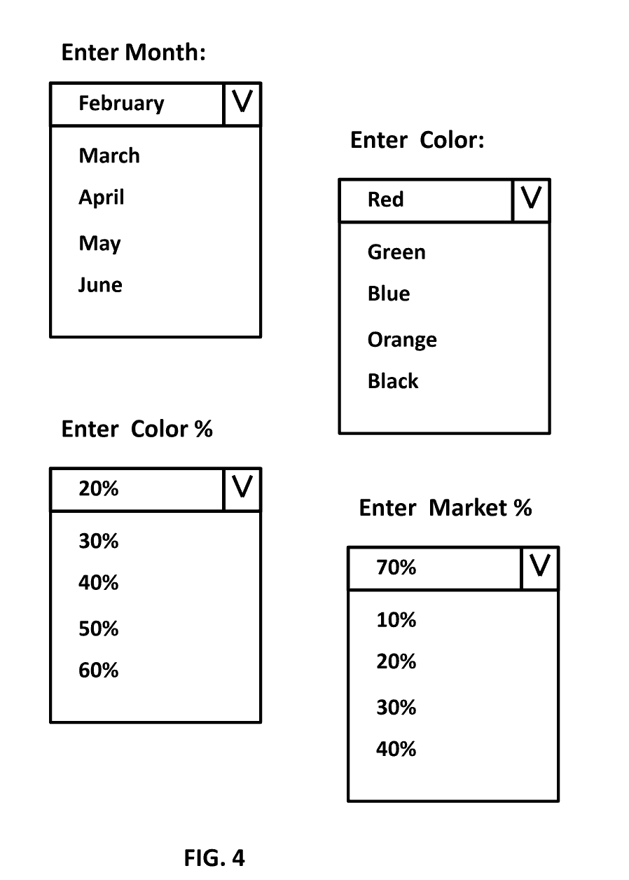

FIG. 5 illustrates an exemplary computer architecture that might be utilized with embodiments of the present invention.

FIG. 6 illustrates an alternative embodiment of the fuzzy-neural system of FIG. 2 in accordance exemplary embodiments of the present invention.

### DETAILED DESCRIPTION OF THE INVENTION

Reference will now be made in detail to the embodiments of the invention, examples of which are illustrated in the accompanying drawings. While the invention will be described in conjunction with the one or more embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

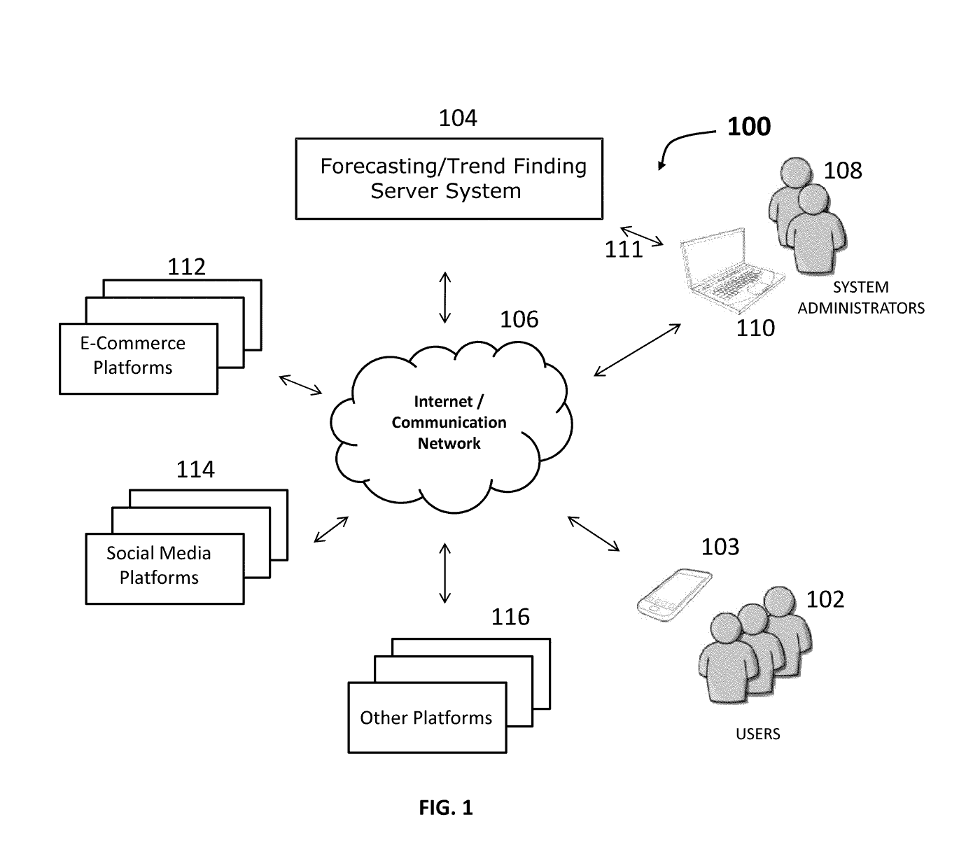

FIG. 1 illustrates preferences communication system 100 according to an exemplary embodiment of the present invention.

In FIG. 1, among other components, preferences communication system 100 includes user(s) 102 communicably coupled to forecasting/trend finding server system 104 via Internet/communication network 106. Although not shown, Internet/communication network 106 represents any distributed network (wired, wireless or otherwise) for data transmission and receipt between two points. The system of the present invention can work effectively with any possible distribution interconnected processors regardless of the specific topology, hardware and protocols used.

In FIG. 1, users 102 may represent individuals, enterprises or any entity such as an apparel manufacturer that wishes to determine future consumer preferences for fashion, trends, style etc. By being cognizant of trends, such entities can tailor their manufacturing output to meet market demand. Another example of user 102 is a departmental store that wishes to order fashion apparel for its upcoming season.

As implied by its name, in FIG. 1, forecasting/trend finding server system 104 can forecast future consumer fashion preferences for the fashion industry (or other like industries) as well as find trends or patterns in the fashion industry. In one embodiment, as will be further discussed, forecasting/trend finding server system 104 employs one or more fuzzy neural networks to generate fashion forecasts and to find trends for use by fashion industry entities e.g., users 102 or other apparel manufacturers to facilitate ordering of the appropriate number of apparels for an upcoming selling season. Other embodiments may use additional algorithms namely decision trees, multiple regression, nearest neighbors and support vector machines for example.

By employing the present invention, entities such as apparel manufacturers, fashion retail outlets, and the like save millions of dollars by not manufacturing apparel that would otherwise be manufactured but not purchased due to lack of consumer demand. Although not shown, forecasting/trend finding server system 104 may include one or more web server as well as one or more application servers including a fuzzy neural network server, all of which systems may be hardware, software or a combination of both.

As shown, preferences communication system 100 further comprises one or more system administrators 108 also coupled to forecasting/trend finding server system 104 via Internet/communication network 106. Specifically, system administrator 108 uses computing device 110 to access forecasting/trend finding server system 104 via Internet/communication network 106. System administrator 108 may also directly access forecasting/trend finding server system 104 via direct communication link 111.

In FIG. 1, preferences communication system 100 further comprises one or more e-commerce platforms 112 also communicably coupled to forecasting/trend finding server system 104 via Internet/communication network 106. E-commerce platform 112 might represent an e-commerce entity that regularly sells products or services via the Internet; and tracks and records sales history data for products and goods that are sold. As an example, e-commerce platform 112 might be Amazon.com®, for example.

Here, either automatically or upon request from forecasting/trend finding server system 104 via appropriate API (Application Programming Interface) calls or similar industry standard mechanism, e-commerce platform 112 generates and forwards or provides sales and/or assortment and pricing information, either actual or historical to forecasting/trend finding server system 104, which sales and/or assortment and pricing data is then utilized by forecasting/trend finding server system 104 to generate fashion forecast data according to principles and precepts of the present invention. Sales and/or assortment and pricing information may also be obtained from e-commerce platform 112 via an RSS (Real Simple Syndication) feed.

In FIG. 1, preferences communication system 100 might also comprise one or more social media platforms 114 communicably attached to forecasting/trend finding server system 104 via Internet/communication network 116. Each social media platform 114 represents a network of social interaction among people including “friends.” Such “friends” can create, share or exchange image data including pictures, video, text and other information types with each other.

The inventor of the present invention views social media as a powerful tool that shows fashion trends particularly among young people. Pictures, videos and other images within social media platform 114 can indicate the current state of fashion by showing colors, brands and other fashion items worn by people in captured images.

Thus, system administrator 112 can capture images and text information via program interfaces and the like. The captured image and text information is then analyzed to determine color and brand content and different fashion features of apparel. The resulting color, brand content and fashion features information is then fed into forecasting/trend finding server system 104.

Preferences communication system 100 further comprises one or more other platforms 116 communicably coupled to forecasting/trend finding server system 104 also via Internet/communication network 106. Other platforms 116 may represent non ecommerce and non social media platforms such as school, individual or community based platforms. Fashion data in the form of color is collected from such platforms for use by forecasting/trend finding server system 104.

In use, system administrator 108 facilitates and oversees the transfer of fashion data from e-commerce platforms 112, social media platforms 114 and other platforms 116 to forecasting/trend finding server system 104. As an example, fashion data may include continuous data such as color information such as the area occupied by a color or the amount of color in a color mix. As another example, fashion data may include discrete information such as brand information (e.g., Nike® brand) or different fashion features of apparel in the captured images or in the text description.

Forecasting/trend finding server system 104 as a decision support system then uses the received fashion data to forecast consumer fashion preferences for the future. A consumer fashion preference is any indication that a consumer likes, exhibits, wears or purchases any fashion or trend related item.

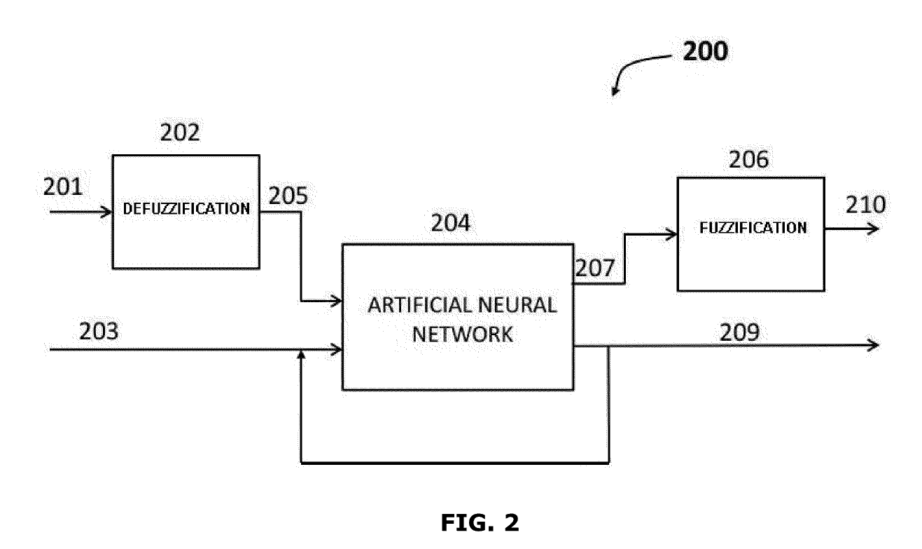

The consumer fashion preference forecast may be for a fixed duration in the future e.g., next month. The consumer fashion preference forecast may indicate the forecasted amount of color for a specific category such as apparel or shoes. An example of a forecast is: 80% of total market for next month would be Nike® and 20% would be Addidas® as will be further discussed with reference to FIG. 2.

One or more users 102 may then use mobile device 103 (for example) to contact forecasting/trend finding server system 104 to obtain the consumer preferences forecasted by the system. Here, user 102 might be a department store for example. As another example, user 102 might be an apparel manufacturer.

Upon receiving the forecasted consumer preferences, user 102 employs the information to order, manufacture or provide fashion services in accordance with the expected forecast. In this manner, by manufacturing apparel based on forecasted consumer preferences, an apparel manufacturer can save not only time, but can conserve hundreds of millions of dollars that would otherwise have been spent on manufactured apparel that would remain unsold due to lack of consumer demand.

FIG. 2 illustrates fuzzy neural network 200 according to an exemplary embodiment of the present invention.

In FIG. 2, users 102 may utilize fuzzy neural network 200 to generate forecasts for consumer fashion preferences. Although not shown, fuzzy neural network 200 is the primary component of forecasting/trend finding server system 104 of FIG. 1. One of ordinary skill in the art will also realize that other analytical models may be used in lieu of or in addition to fuzzy neural network 200. Without limitation, such models may include decision trees, multiple regression, nearest neighbors, and support vector machines.

In FIG. 2, here, consumer fashion preferences might include consumer preferences for color. As another example, consumer preferences may include brand preferences.

As shown, fuzzy neural network 200 comprises defuzzification unit or algorithm 202 having input 201 that receives continuous color or text or apparel fashion features data and output 205 coupled to artificial neural network 204. Although not shown, additional fuzzy inputs other than input 201 may be used. Here, the continuous color or text or apparel fashion features might be in form of fuzzy sets. Fuzzy sets are mathematical elements that have degrees of membership. Degrees of membership means that the characteristic that qualifies the elements for membership is evaluated based on degree or gradation. The range for mapping the gradations is 0 through 1. Thus a dress with a color green might be “a little bit green” with a value of 0.2 but still qualifies for membership as being in the set of dresses with color green.

As another example the fuzzy set can be used to define whether a product belongs to a certain color. A dress may consist of parts having different colors. It could then be said that the dress is “predominantly red” or “a little bit green”. A color itself may be called for instance “close to orange”. In such cases membership of the dress in the corresponding fuzzy set (for instance, “orange”, “red” or “green”) is defined by a corresponding membership function. This description also applies to other fuzzy sets relevant to the fashion industry.

In FIG. 2, defuzzification unit 202 defuzzifies or uses the fuzzy sets to generate at least one discrete value most representative of the fuzzy set. Here, defuzzification unit 202 may employ any known defuzzification algorithm including weighted average, max membership, centriod method for example or other know defuzzification algorithms . . . .

Defuzzification and fuzzification algorithms are used to transform fuzzy sets such as described above to discrete sets. Those algorithms may use for example percentage of dress surface having a particular color or corresponding RGB values for a specific color or other applicable discrete values. In one embodiment, defuzzified data is used as artificial neural network input along with discrete sets such as the one of brand names. Neural network output is then fuzzified in order to present the results in the form similar to initial fuzzy set used for input.

Note that text and numerical information about fashion features of apparel can be processed not only by structural algorithms such as fuzzy-neural, decision trees, clusterization, nearest neighbors, support vector machines, but also with statistical algorithms, such as different types of regression.

Having the multiple inputs such as color, balance depot stock, number of Twitter™ followers, etc. as independent variables influencing on dependent variable, for example, price or sales volume, the generic multiple regression function is represented in D-dimensional curve:

yi=w0h0(xi)+w1h1(xi)+ . . . +wDhD(xi)+εi

yi=Σᵢ₌₀^{D}wjhj(xi)+εi

where
N—# observations (xi,yi)
d—# inputs x[j]
D—# features hj(x)
feature 0=h0(x) . . . e.g., 1
feature 1=h1(x) . . . e.g., x[1]=% color
feature 2=h2(x) . . . e.g., x[2]=balance depot stock
feature 3=h2(x) . . . e.g., x[2]=# Twitter™ followers
or, log(x[7]) x[2]=log(balance depot stock) x # Twitter™ followers [symbol]
feature D+1=hD(x) . . . some other function of x[1], . . . , x[d]

For generically, instead of a hyperplane represented by simple multiple regression, some D-dimensional curve is fitted. This is capital D-dimensional curve, because there is some capital D different features of the multiple inputs. In one embodiment, as an example, the zero feature may be one constant term that just shifts up and down where this curve leads in the space and the first feature might be just color percentage. Other examples are possible.

In a further embodiment, the second feature could be the balance depot stock. Further yet, a third feature could be some other function of any of the inputs. For example, here it is a log of the second input, which here is balance depot stock, multiplied by the number of Twitter™ followers. Therefore, in this case the second feature of the model relates log balance depot stock multiplied by the number Twitter™ followers to the output. Then the capital D feature which is some function of any of other inputs to the regression model. Thus, the generic multiple regression model with multiple features is created. The big sum can be represented with the Capital sigma notation. In this formula, Yi, equals the sum of Wj, Hj of X, plus Epsilon i.

In another embodiment, having different retailers' sales data, the sales of a new retailer might be predicted by using nearest neighbor regression. Nearest neighbor regression collects some set of data points, and predicting the value at any point in the input space. The algorithm looks for the closest observation that is going to be predicted and what its outputted value is, and then predicts that the value is exactly equivalent to that value. This leads to having local fits where such local fits are defined around each one of the observations. And how local the fits are and how far they stretch is based on the placement of other observations.

Formalization the nearest neighbor method: having some data set of retailers' sales data. It might be pairs of retailer attributes and values associated with each retailer. This is denoted as (x, y) for some set of observations, 1 to capital N. So this is the data set. Then it is assumed that there is some query retailers' sales, which is not in the training data set.

This is some point, xk, some retailer that is interested in the value. And the first step of the nearest neighbor method is to find the closest other retailer in the dataset. Specifically it called x nearest neighbor to be the retailer that minimizes over all observations, i, the distance between xi and the query retailer, xk. Then the value of that retailer is the nearest neighbor. One primary aspect in the nearest neighbor method is obtaining this distance metric, which measures how similar this query retailer is to any other retailer.

Scaled Euclidean distance is achieved via

distance(xj,xq)={square root over (a1(xj[1]−xq[1]2+ . . . +ad(xj[d]−xq[d])2)}

where
a1 . . . ad—weight on each input (defining relative importance)

Other examples of distance metrics might be utilized including, without limitation: Mahalanobis, rank-based, correlation-based, cosine similarity, Manhattan, Hamming, etc.

In FIG. 2, artificial neural network 204 receives input 203 that includes discrete information such as brand name or text fashion features of apparel and provides output 209 that includes for example brand name trends; artificial neural network 204 also receives defuzzified input 205 and provides output 207 that is then fuzzified in order to present results in the form similar to initial fuzzy set used for input.

To retrieve input 203 from the raw data the following algorithms are used: descriptive analysis; correlation; analysis related to iterative methods of clusterization; factor analysis; analysis of variance; multivariate regression analysis. For instance, data for initial dataset of different fabrics as one of text fashion features of apparel is contained in product description.

In one embodiment, text and numerical information about fashion features of apparel is processed not only by structural algorithms such as fuzzy-neural, decision trees, clusterization, nearest neighbors, support vector machines, but also with statistical algorithms such as different types of regression.

Artificial neural network 204 is modeled to simulate the brain electronically. The human brain consists of about 100 billion tiny units known as neurons, with each neuron being connected to other neurons (thousands) and communicating with each other via electrochemical signals.

Signals into the neuron are received via end units called synapses, located at the end (dendrites) of branches of the neuron cell. The neuron continuously receives signals then generally attempts to sum up the inputs; and if the summed up result is greater than some threshold value, the neuron fires, generating a voltage that outputs at an axon (neuron transmitter).

Artificial neural network 204 includes a plurality of electronic neurons (not shown) that are modeled after biological neurons. In one embodiment, the neurons are connected in a feed forward network, where each neuron has multiple inputs and a single output connected to an input of the next neuron. Each input also has a weight that is associated with the neuron.

When an input is received, it is multiplied by the weight, which can either be positive or negative. If the summed output is more than a threshold, then the neuron outputs a signal, otherwise said output is low. Here, an example of an input might be Month representing January, February, etc.

In use, continuous information such as color information is entered at input 201; discrete information such as brand or text fashion features of apparel name information is entered at input 203. In practice, many apparel are multicolored, and in such case, the predominant color must be determined to create more meaningful input 201. This issue is solved with applying k-nearest method and iterative methods of clusterization. Future consumer preference information such as a color preference is output at output 210 while output 209 provides trend or future consumer preference information such as brand name information.

Input, i.e. consumer preferences for color may be expressed as percentages, for example, 35%-38% red and 40%-43% green. Output forecast can similarly be expressed as percentages. For example, output may be 38%-47% red and 37%-40% green. Such percentages may be applicable to the entire market or sub-segments of the market.

Inputs for brands can also be expressed as percentages. For example, the input for a given month may be expressed as 40% Nike®, 40% Addidas® and 20% Arena™. The output, i.e., forecasted consumer preferences for the six months later, for example, may be expressed as 35% Nike®, 50% Addidas® and 15% Arena. In this manner, a retailer, for example, will order more of Addidas® sales of which is projected to increase, and less of Nike®, of which sales is projected to decrease.

Initially, fuzzy neural network 200 is tuned and/or trained to increase accuracy of consumer preferences forecast and trends. Thus, first, actual consumer preference data for November, December, January, February and March is collected by system administrator 108.

Thereafter, system administrator 108 begins by entering at inputs 201 and 203, the actual consumer preference data for November, December and January. The data for these three months is then used to define consumer preference data for February, where the February forecast data is output at 209, 210.

The February forecast data and then February actual data are then compared. Fuzzy neural network 200 is then continuously tuned (e.g. by adjusting weights associated with each input) until the February forecast data is relatively close to February's actual data.

Next, the February data is then entered at inputs 201, 203, so that the system now has four months of data for November, December, January and February. The data for these four months is the used to forecast consumer preference data for March, the March forecast data being output at 209, 210.

The March forecast data and the March actual data are then compared. Here, fuzzy neural network is then continuously tuned (e.g. by adjusting weights associated with each input) until the March forecast data and the March actual data are relatively close, while simultaneously ensuring that tuning does not reduce the accuracy of the February forecast data.

By self learning, fuzzy neural network 200 increases the accuracy of consumer preference forecasts. Periodically, the actual data and the forecasted data are compared and tuned; the system gets better and becomes more accurate at forecasting.

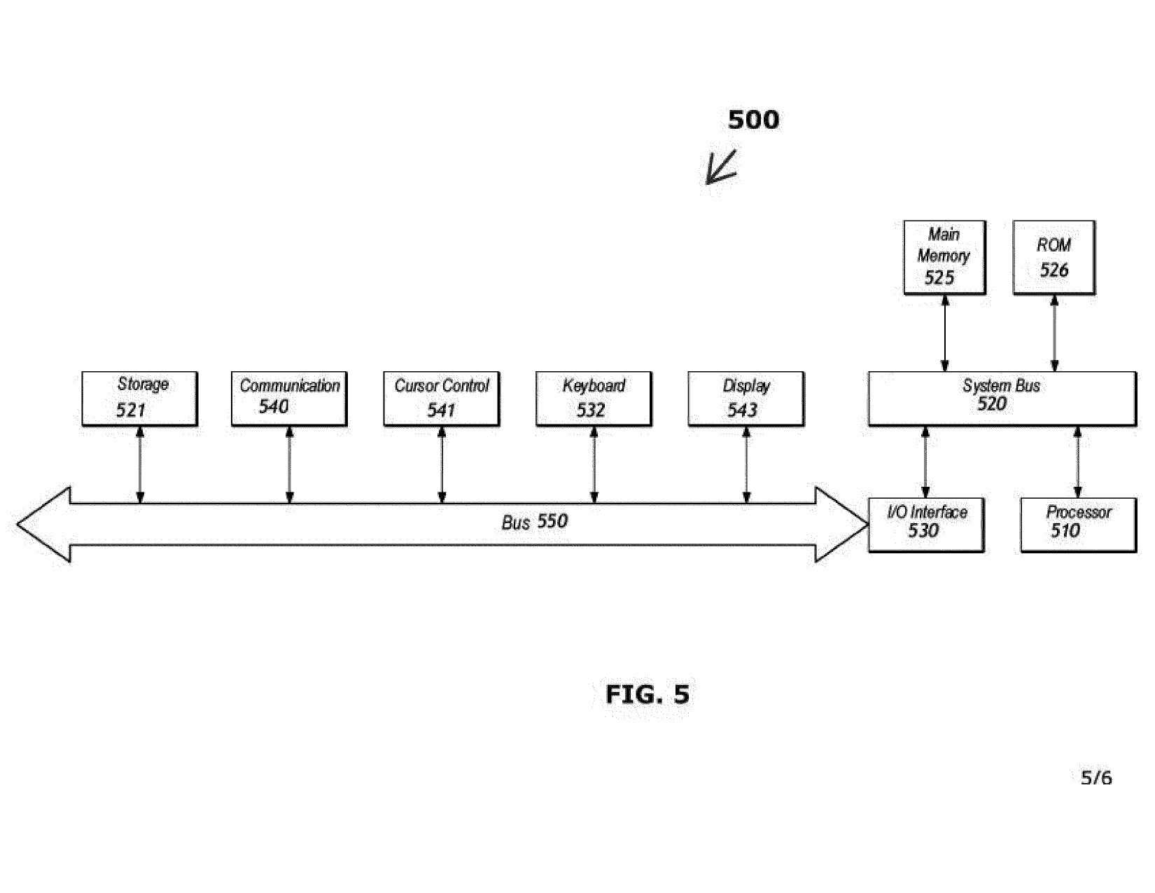

FIG. 5 illustrates computer system architecture 500 for use with an exemplary embodiment of the present invention.

In one embodiment, computer system architecture 500 comprises system bus 520 for communicating information and processor 510 coupled to system bus 520 for processing information. Computer system architecture 500 further comprises a random access memory (RAM) or other dynamic storage device 525 (referred to herein as main memory), coupled to system bus 520 for storing information and instructions to be executed by processor 510. Main memory 525 may also be used for storing temporary variables or other intermediate information during execution of instructions by processor 510. Computer system architecture 500 may also include a read only memory (ROM) 526 coupled to system bus 520 for storing static information and instructions used by processor 510.

Computer system architecture 500 can also include a second bus 550 coupled via I/O interface 530 to system bus 520. A plurality of I/O devices may be coupled to bus 550, 15 including display device 543, an input device (e.g., alphanumeric input device 532 and/or cursor control device 541). A data storage device 521 such as a magnetic disk or optical disc and its corresponding drive may also be coupled to bus 550 for storing information and instructions. The instructions may be one or more line of software code stored on a disk, flash drive and the like or downloadable via a communication network such as the Internet. The one or more lines of software code may include defuzzification and fuzzification algorithms, and artificial neural network code for embodiments of the present invention. Communication device 540 allows for access to other computers (e.g., servers or clients) via a network. Communication device 540 may comprise one or more modems, network interface cards, wireless network interfaces or other interface devices such as those used for coupling to Ethernet, token ring, or other types of networks.

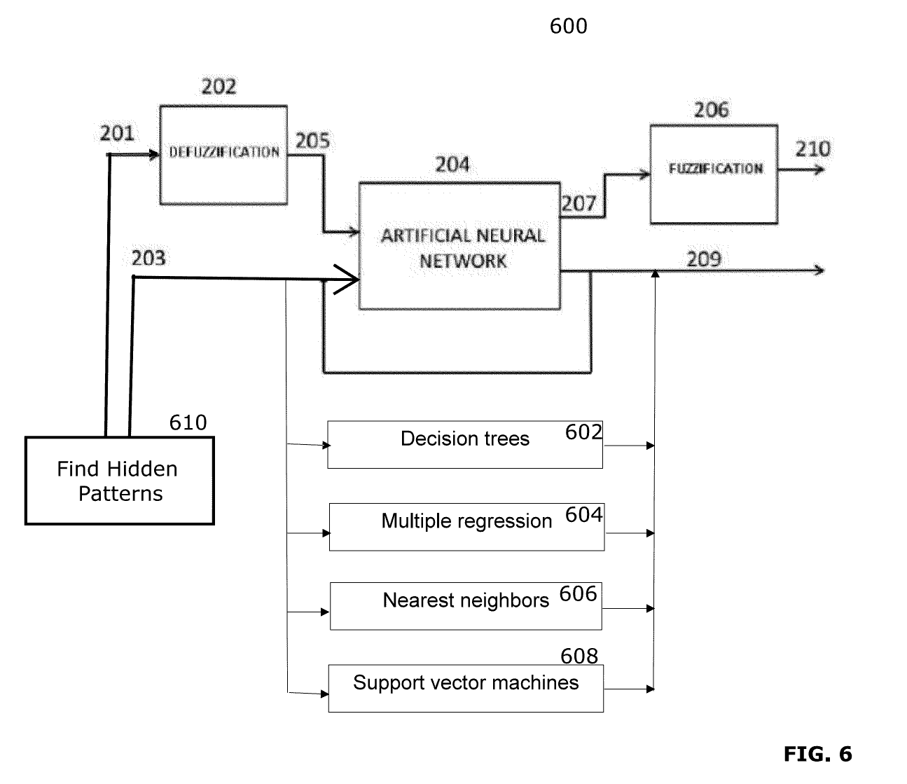

FIG. 6 illustrates an alternative embodiment of the fuzzy-neural system of FIG. 2 in accordance exemplary embodiments of the present invention. Unlike in FIG. 2, fuzzy neural system 600 of FIG. 6 includes additional algorithms namely decision trees 602, multiple regression 604, nearest neighbors 606 and support vector machines 606. As implied by its name, find hidden patterns 610 unit locates hidden patterns within raw data for the inputs by using one or more of hidden descriptive analysis, correlation, analysis related to iterative methods of clusterization, factor analysis, analysis of variance, multivariate regression analysis, without limitation. As shown the algorithms are in parallel with artificial neural network 202 so that one or more of the algorithms can be used in addition to or in lieu of artificial neural network 204.

To find hidden patterns and identify trends between unstructured text and numerical data about fashion features of apparel, embodiments of the present invention may identify patterns of conditional logic (classification and clustering with the short description of objects of close or similar groups) and also identify patterns of associative logic (objectives of the association and sequences and the retrieved with their help information).

Embodiments of the present invention may also identify trends and variations. The aforementioned identification can by descriptive analysis and/or correlation.

It might also be by analysis related to iterative methods of clusterization, factor analysis, analysis of variance and/or multivariate regression analysis.

Application of these methods is associated not only with the unstructured text and numerical data about fashion features of apparel, but also with bringing them into a comparable form (data normalization) for further processing and forecasting.

This system may also provide what-if analysis capabilities, for instance, by answering a question of how consumers' behavior would change in the future if seller or manufacturer changed its behavior today.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A computer-implemented method comprising:
receiving by a server, at least two datasets including a first dataset and a second dataset,
wherein the first dataset is at least continuous color data, said at least continuous color data being applied to a defuzzification unit;
wherein the second dataset is discrete brand data, said discrete brand data being applied to an artificial neural network;
generating a third dataset based on the first dataset that is applied to the defuzzification unit, said third dataset being applied to the artificial neural network;
generating a fourth dataset and a fifth dataset based on the second dataset and the third dataset applied to the artificial neural network, said fourth dataset being applied to a fuzzification unit and said fifth dataset indicating at least consumer brand preference information; and
generating a sixth dataset based on the fourth dataset applied to the fuzzification unit, said sixth dataset indicating at least consumer color preference information.

2. The method of claim 1 wherein the first dataset further comprises fashion features data for apparel.

3. The method of claim 1 wherein the third dataset includes at least discrete color data for apparel.

4. The method of claim 1 further comprising feeding back the fifth dataset to the artificial neural network to train said artificial neural network.

5. The method of claim 1 wherein the consumer color preference information is as associated with future time duration.

6. A computer program product including a non-transitory computer readable storage medium and including computer executable code, which when executed by a processor adapted to perform the steps comprising:
receiving at least two datasets including a first dataset and a second dataset, wherein the first dataset is at least continuous color data, wherein the second dataset is at least discrete brand data;
generating a third dataset based on the first dataset;
generating a fourth dataset and a fifth dataset based on the second dataset and the third dataset, said fifth dataset indicating at least consumer brand preference information; and
generating a sixth dataset based on the fourth dataset, said sixth dataset indicating at least consumer color preference information.

7. The computer program product of claim 6 wherein the first dataset further comprises fashion features data for apparel.

8. The computer program product of claim 6 wherein the third dataset includes at least discrete color data for apparel.

9. The computer program product of claim 6 further comprising feeding back the fifth dataset to an artificial neural network to train said artificial neural network.

10. The computer program product of claim 6 wherein the consumer color preference information is as associated with future time duration.

11. A computer-implemented method comprising:
receiving by a server, at least two datasets including a first dataset and a second dataset,
wherein the first dataset is at least continuous color data, said at least continuous color data being applied to a defuzzification unit;
wherein the second dataset is discrete brand data, said discrete brand data being applied to any one or more of an artificial neural network, decision tree unit, multiple regression unit, nearest neighbors unit and support vector machines unit;
generating a third dataset based on the first dataset that is applied to the defuzzification unit, said third dataset being applied to the artificial neural network;
generating a fourth dataset and a fifth dataset based on the second dataset and the third dataset applied to the any one or more of the artificial neural network, decision tree unit, multiple regression unit, nearest neighbors unit and support vector machines unit, said fourth dataset being applied to a fuzzification unit and said fifth dataset indicating at least consumer brand preference information; and
generating a sixth dataset based on the fourth dataset applied to the fuzzification unit, said sixth dataset indicating at least consumer color preference information.

12. The method of claim 11 wherein the first dataset further comprises fashion features data for apparel.

13. The method of claim 11 wherein the third dataset includes at least discrete color data for apparel.

14. The method of claim 11 further comprising feeding back the fifth dataset to the artificial neural network to train said artificial neural network.

15. The method of claim 11 wherein the consumer color preference information is as associated with future time duration.
